(19) United States
(12) Patent Application Publication
(10) Pub. No.: US 2021/0279534 A1
(43) Pub. Date: Sep. 9, 2021

(54) PRINT MODE QUALITY SELECTION

(71) Applicant: Hewlett-Packard Development Company, L.P., Spring, TX (US)

(72) Inventors: Joseph W. Stellbrink, Corvallis, OR (US); April E. Sullivan, Corvallis, OR (US)

(73) Assignee: Hewlett-Packard Development Company, L.P., Spring, TX (US)

(21) Appl. No.: 16/330,557

(22) PCT Filed: Sep. 21, 2016
(86) PCT No.: PCT/US2016/052852

§ 371 Date: Mar. 5, 2019

(51) Int. Cl. G06K 15/02

(52) U.S. Cl. CPC G06K 15/1809; G06K 15/1822; G06K 15/1836; G06K 15/1849; G06K 15/1807

(57) ABSTRACT

In some examples, print mode quality selection may include determining, based on a preliminary rendering of print data, resulting pixel tones. Print mode quality selection may further include generating raster data based at least in part on a further rendering of the print data, and generating further print data including the raster data and a specified print mode.

### BACKGROUND

A printing device, such as a printer, multifunction printer, and/or other such devices may be described as a peripheral which is used to make a persistent human readable representation of graphics or text on physical media such as paper. For an ink based printing device, printing material (e.g., ink) may be ejected onto a physical medium to thereby print content onto the physical medium.

### BRIEF DESCRIPTION OF DRAWINGS

Features of the present disclosure are illustrated by way of example and not limited in the following figure(s), in which like numerals indicate like elements, in which:

FIG. 1 illustrates a layout of a print mode quality selection system, according to an example of the present disclosure;

FIG. 2 illustrates a block diagram for print mode quality selection, according to an example of the present disclosure;

FIG. 3 illustrates a flowchart of a method for print mode quality selection, according to an example of the present disclosure; and

FIG. 4 illustrates a further block diagram for print mode quality selection, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

A print mode quality selection system, a method for print mode quality selection, and a non-transitory computer readable medium having stored thereon machine readable instructions to provide print mode quality selection are disclosed herein. The system, method, and non-transitory computer readable medium disclosed herein provide for print mode selection for a print job based on a preliminary rendering, printing material separation, and tonal classification of print data. That is, the system, method, and non-transitory computer readable medium disclosed herein provide for classification of tonal characteristics of incoming print data, and selection of a print mode with the most appropriate grain quality based, for example, on the presence of groups of pixels with specific tonal classifications.

For the system, method, and non-transitory computer readable medium disclosed herein, printing material may comprise consumable fluids as well as other consumable materials. Printing material may comprise ink, toner, fluids, powders, colorants, varnishes, finishes, gloss enhancers, binders, and/or other such materials that may be utilized in a printing process.

For the system, method, and non-transitory computer readable medium disclosed herein, examples of print modes include a dual drop weight print mode (i.e., printing with both large and small drops of printing material), a multi-drop weight print mode (e.g., where the drops of printing material may include small, medium, or large drops), a light printing material print mode (e.g., where a base printing material set includes CMYK printing materials, and to reduce grain, a lighter printing material set including CMYK printing materials with reduced pigment is also used), etc. For the CMYK color scheme, C represents cyan, M represents magenta, Y represents yellow, and K represents black.

For the system, method, and non-transitory computer readable medium disclosed herein, the preliminary rendering may represent a full-resolution (or a low-resolution) rendering using a same color management as a further rendering of the print data. The further rendering may be used to generate raster data. The color management may be described as the process by which an image (e.g., a RGB image, where R represents red, G represents green, and B represents blue, is transformed to another format, such as a CMYK format).

For the system, method, and non-transitory computer readable medium disclosed herein, the printing material separation may represent a plane of the preliminary rendering. That is, the printing material separation may represent the data that will be printed for a particular colorant. For example, for a CMYK color scheme, a printing material separation may represent data for a data plane that will be printed by a printhead that prints cyan, data for a data plane that will be printed by a printhead that prints magenta, etc.

For the system, method, and non-transitory computer readable medium disclosed herein, the tonal classification may represent a type (e.g., light, medium, or dark, or another category) of printing material for a particular pixel based on specified tonal characteristics of the pixel. For example, tonal characteristics of less than 20% magenta (or a combination of printing material colors) may represent a light tonal classification, whereas tonal characteristics of greater than 80% magenta may represent a dark tonal classification.

For the system, method, and non-transitory computer readable medium disclosed herein, with respect to groups of pixels with specific tonal classifications, a group of pixels (or an object as disclosed herein) may be described as a predetermined number (e.g., n×n, or a circle including a radius of n, etc.) of adjacently disposed pixels. In some examples, a group of pixels for a relatively small image (e.g., for a 7 cm×12 cm photograph) may be defined as a relatively small number (e.g., 10) of adjacently disposed pixels, whereas a group of pixels for a relatively large image (e.g., for a 3 m×6 m billboard) may be defined as a relatively large number (e.g., 200) of adjacently disposed pixels. For example, the group of pixels may be described as a 10×10 square (or circular, or another form) of adjacently disposed pixels. The aspect of utilizing a group of pixels for tonal classifications may eliminate randomly scattered pixels from impacting the tonal classification as disclosed herein. The objects may be used in a sliding manner (e.g., a pixel at a time), such as across and down the preliminary rendering, to analyze the preliminary rendering in a step-by-step manner. Once a particular criteria being analyzed with respect to the objects is met (e.g., a low-grain print mode is needed as disclosed herein), further analysis of the preliminary rendering may be stopped.

In printer systems such as digital inkjet printing devices, different printing modes may provide trade-offs in quality versus print speed. For example, higher quality print modes may include printing with separate fluid ejectors or printheads that eject smaller drops and/or drops of lighter printing materials (e.g., light cyan (C) or magenta (M)) in order to produce smoother tints and tones. The benefit of these print modes may be referred to as “reduced grain” or “low-grain” (as opposed to “high-grain” or “coarse-grain” print modes), and may be noticeably visible in lighter tones (e.g., skin tones, light neutrals, highlights, etc.). Due to factors such as data path sizes, printhead configurations, etc., these higher quality print modes may utilize reduced print speeds, which in turn may result in the reduction of productivity of a digital printing press.

With respect to higher quality print modes, printing costs for such print modes may also be higher due to the additional printing material that is used to maintain and potentially monitor the additional printhead fluid ejectors (i.e., fluid ejector “spitting” and printhead health strips). Further, small amounts of paper may also be wasted to enable printing using these additional fluid ejectors and printing materials (e.g., where “chipout” sizes may be dependent on the number of active printing materials or printheads). For example, the greater the number of active printing materials or printheads, the greater the “chipout” sizes, resulting in greater paper wastage. For cases where fluid ejectors are fired randomly in the printed content to maintain printhead health, enabling additional fluid ejectors may reduce the perceived quality of the printed output as additional random firings become more visible. Additional costs may also be incurred in wiping and servicing of the additional fluid ejectors and printing materials, in the form of web wipe material consumption. Accordingly, selection of a higher-than-needed quality print mode may result in unnecessary overhead.

The system, method, and non-transitory computer readable medium disclosed herein overcome these technical challenges in printing systems by generating a preliminary rendering of print data to determine resulting tones within each printing material separation (e.g., for each CMYK plane). In some examples, a threshold may be used to classify the tone of each object defined by a predetermined number of adjacently disposed pixels. For example, for an object defined by a 10×10 square, the threshold may represent a number of pixels (e.g., 40 pixels for a 10×10 square that includes 100 pixels) of the object that are a certain tone (e.g., light, medium, or dark). Alternatively or additionally, the threshold may represent a number of adjacently disposed pixels of the object that are a certain tone. Alternatively or additionally, the threshold may include a plurality of thresholds associated with different pixel tones (e.g., a first threshold for light tones, a second threshold for medium tones, etc.). Alternatively or additionally, the threshold may be based on whether any pixel of an image includes a particular tone. Based on the classification, a determination is made as to whether any tones are present that would benefit from a higher quality print mode. If so, a higher quality print mode may be selected for the print job, and otherwise, a lower (but adequate) quality print mode may be selected for the print job.

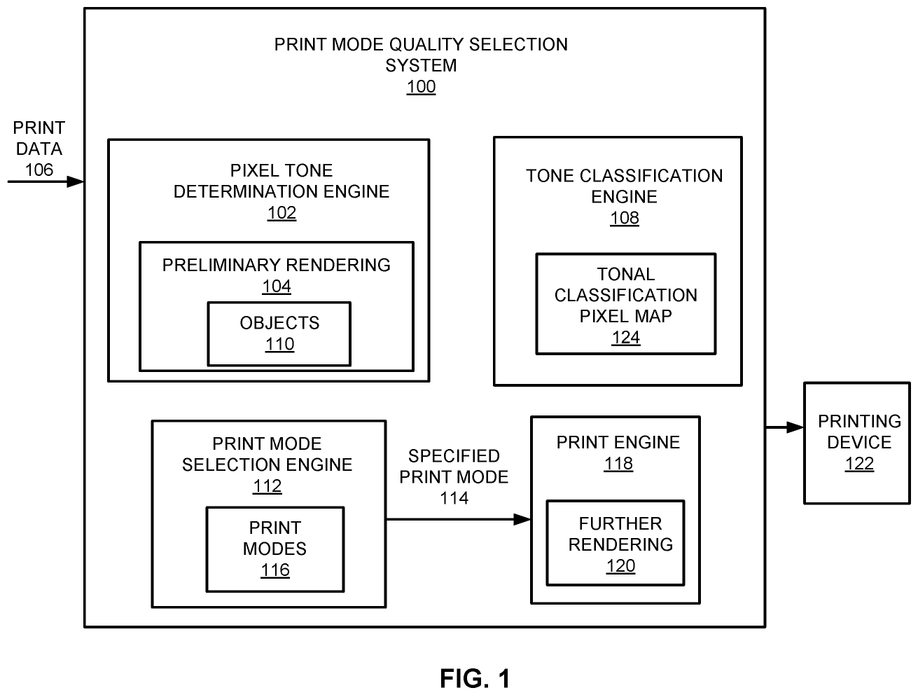

FIG. 1 illustrates a layout of a print mode quality selection system (hereinafter also referred to as “system 100”), according to an example of the present disclosure. In some examples, the system 100 may include or be provided as a component of a print server for processing print data before the processed print data is transmitted to a printing system, such as an inkjet printer, or any type of printing device. For example, the system 100 may perform print job processing before the print job is sent to a printing system that includes a high-speed press. Alternatively, the system 100 may be a component of a printing device.

Engines, as described herein, may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to execute those instructions. In these examples, a computing device implementing such engines may include the machine-readable storage medium storing the instructions and the processing resource to execute the instructions, or the machine-readable storage medium may be separately stored and accessible by the computing device and the processing resource. In some examples, some engines may be implemented in circuitry.

Referring to FIG. 1, the system 100 may include a pixel tone determination engine 102 to determine, based on a preliminary rendering 104 of print data 106, resulting pixel tones within each printing material separation of a plurality of printing material separations. A printing material separation may represent a printing material plane of the preliminary rendering 104.

The system 100 may further include a tone classification engine 108 to classify, based on the resulting pixel tones, a tone of each object of a plurality of objects 110 of the preliminary rendering 104 by comparing the tone of each object of the plurality of objects to a tone threshold. An object may include a plurality of adjacently disposed pixels.

The system 100 may further include a print mode selection engine 112 to select a specified print mode 114 of a plurality of print modes 116 to meet the classification of the tone of each object.

The system 100 may further include a print engine 118 to generate, based on the specified print mode 114, a further rendering 120 of the print data 106. Further, the print engine 118 may utilize the further rendering 120 to cause a printing device 122 to generate a print job from the print data 106. For example, the print engine 118 may generate raster data based at least in part on the further rendering 120 of the print data 106, and generate further print data including the raster data and the specified print mode 114.

As will be appreciated, some examples of the system 100 may be configured with more or less engines, where engines may be configured to perform more or less operations. Furthermore, in some examples, the engines may be implemented by execution of instructions with a processing resource to cause the processing resource to perform the corresponding operations.

Referring again to FIG. 1, operation of the system 100 is described in further detail.

The pixel tone determination engine 102 may determine, based on the preliminary rendering 104 of the print data 106, resulting pixel tones within each printing material separation of the plurality of printing material separations. In this regard, the pixel tone determination engine 102 may generate a full-resolution rendering using a same color management as the further rendering 120 of the print data 106. A full-resolution rendering may be described as a rendering generated at a same resolution as the further rendering 120 of the print data. For example, a full-resolution rendering may be described as a 600×600 pixels per inch rendering, which corresponds to the same resolution as the further rendering 120 of the print data. The full-resolution rendering may represent the preliminary rendering 104, and the further rendering 120 may be generated based on the specified print mode 114 and is to be used by the print engine 118 to generate a print job for the printing device 122. The color management associated with the further rendering 120 of the print data 106 may include the values (e.g., the CMYK values) of the particular printing materials for pixels. Further, the pixel tone determination engine 102 may determine, based on the preliminary rendering 104 of the print data 106, resulting pixel tones within each printing material separation of the plurality of printing material separations.

In some examples, instead of the preliminary rendering being performed as a full-resolution rendering, the preliminary rendering may be performed at a lower resolution to reduce the level of computation needed. A lower resolution rendering may be described as a rendering that includes a lower resolution compared to the further rendering 120 of the print data. For example, assuming that a full-resolution rendering includes 600×600 pixels per inch, if objects 110 of a size of 20×20 pixels are being analyzed for tonal classification, a lower resolution rendering of 100×100 pixels per inch may be used with objects 110 including a size of 5×5 pixels as such a lower resolution rendering would be adequate for analysis of such objects. In this regard, any impact on the determination of the specified print mode 114 may be negligible since small areas of light tones (e.g., areas of a size smaller than the objects 110) are typically in noisier areas of image content, and such small areas may not benefit from the use of a low-grain print mode.

The tone classification engine 108 may classify, based on the resulting pixel tones, a tone of each object of the plurality of objects 110 of the preliminary rendering 104 by comparing the tone of each object of the plurality of objects to a tone threshold. In this regard, the tone classification engine 108 may analyze the printing material separations from the preliminary rendering 104 and determine whether the resulting pixel tones are sufficiently light to benefit from a higher quality print mode.

The classification may include a threshold comparison of the maximum tone value for that pixel location across all the separations. In this regard, the tone classification engine 108 may classify a maximum tone of each pixel of the preliminary rendering 104 by determining whether the maximum tone of a pixel is less than the tone threshold (or a different threshold associated with pixels). Further, in response to a determination that the maximum tone of the pixel is less than the tone threshold, the tone classification engine 108 may classify the pixel as including a specified tone (e.g., a light tone, a medium tone, etc.). For example, for a CMYK color scheme, a maximum tone of 40% K (where C may include a tone of 30%, M may include a tone of 0%, Y may include a tone of 20%, and K may include a tone of 40%) of a pixel is less than the tone threshold of 60%, the tone classification engine 108 may classify the pixel as a light tone. In this manner, all pixels of the preliminary rendering 104 may be classified.

With respect to the maximum tone value for a pixel location across all the separations, if the maximum value across all separations is zero (i.e., max [C, M, Y, K]=0), the pixel may be flagged as “dark” in order to avoid selection of a low-grain print mode for that pixel as such a pixel is not printed.

Once all of the pixels of the preliminary rendering 104 are classified as a particular tone (e.g., light, medium, dark, etc.), the objects 110 may be classified in accordance with the various classification criteria disclosed herein. In this regard, the tone classification engine 108 may classify, based on the specified tone of each pixel, the tone of each object of the plurality of objects 110 by determining whether a predetermined number of the classified pixels of an object of the plurality of objects 110 include the specified tone (e.g., a light tone, a medium tone, etc.). Further, in response to a determination that the predetermined number of the classified pixels of the object of the plurality of objects 110 include the specified tone, the tone classification engine 108 may classify the tone of the object as the specified tone. For example, if a percentage (or number) based classification criteria is applied, an object may be classified as a particular tone if a percentage (or number) of the pixels of the object are a particular tone (e.g., 30% of the pixels of a 10×10 pixels object are a particular tone, where a threshold associated with the object is 25% of the pixels).

With respect to tonal classification by the tone classification engine 108, in some examples, the tone classification engine 108 may classify a maximum tone of each pixel of the preliminary rendering 104 by determining whether the maximum tone of a pixel is less than the tone threshold (or a different threshold associated with pixels). In response to a determination that the maximum tone of the pixel is less than the tone threshold, the tone classification engine 108 may classify the pixel as including a first specified tone. In response to a determination that the maximum tone of the pixel is greater than the tone threshold, the tone classification engine 108 may classify the pixel as including a second specified tone. Further, with respect to classifying, based on the first and second specified tones of each pixel, the tone of each object of the plurality of objects, the tone classification engine 108 may determine whether a predetermined number of the classified pixels of an object of the plurality of objects 110 include the first specified tone, and whether a predetermined number of the classified pixels of the object of the plurality of objects 110 include the second specified tone. Further, in response to a determination that the predetermined number of the classified pixels of the object of the plurality of objects 110 include the first specified tone or the predetermined number of the classified pixels of the object of the plurality of objects 110 include the second specified tone, the tone classification engine 108 may classify the tone of the object as the first or the second specified tone.

With respect to tonal classification by the tone classification engine 108, in some examples, a yellow separation may be omitted because of its negligible impact on tonal smoothness. In this regard, other printing material separations may each be independently compared to unique threshold values that are based on the density of the printing material used in the separation and the visibility difference between large and small drops of printing material, or light and dark printing materials. For example, for a CMYK color scheme, the C, M, and K printing material separations may be independently compared to unique threshold values (e.g., 50% for C, 50% for M, and 25% for K) that are based on the density of the printing material used in the separation and the visibility difference between the large and small drops of printing material, or light and dark printing materials. In this regard, a yellow separation may be omitted by effectively setting a high threshold for the Y printing material separation, for example, of 100%. Further, with respect to the aspect of the visibility difference between the large and small drops of printing material, or light and dark printing materials, different thresholds may be used for large versus small drops, or light versus dark printing materials (i.e., where dark printing materials include more pigment compared to light printing materials). Further, if a non-zero pixel includes light tones (and no other tones) in one or more of the separations, the non-zero pixel may be classified as a light tone that may benefit from a low-grain print mode.

With respect to tonal classification by the tone classification engine 108, in some examples, the tone classification engine 108 may determine a weighted sum of the tone values across all printing material separations for a given pixel. In this regard, the tone classification engine 108 may use weighting factors to account for the differences in grain visibility between different printing materials. For example, the tone classification engine 108 may determine, based on the preliminary rendering 104 of the print data 106, resulting pixel tones within each printing material separation of the plurality of printing material separations by multiplying each printing material separation by a weight corresponding to a type of the printing material separation, and determining, based on the multiplied printing material separations, a combined pixel tone value for each pixel. The tone classification engine 108 may classify the combined pixel tone value of each pixel of the preliminary rendering 104 by determining whether the combined pixel tone value of a pixel is less than the tone threshold (where the tone threshold in this regard may be a different threshold than the threshold used for objects). In response to a determination that the combined pixel tone value of the pixel is less than the tone threshold, the tone classification engine 108 may classify the pixel as including a specified tone. The tone classification engine 108 may classify, based on the specified tone of each pixel, the tone of each object of the plurality of objects 110 by determining whether a predetermined number of the classified pixels of an object of the plurality of objects 110 include the specified tone. Further, in response to a determination that the predetermined number of the classified pixels of the object of the plurality of objects 110 include the specified tone, the tone classification engine 108 may classify the tone of the object as the specified tone.

For example, with respect to the CMYK color scheme, the CMYK weights of {1, 1, 0, 2} may be used when combining the tone values to account for the invisibility of yellow grain and the higher contrast of black drops. In this regard, because of the negligible impact of yellow on tonal smoothness, yellow may be assigned a weight of “0”. With respect to the CMYK weights of {1, 1, 0, 2}, in some examples, assuming that a pixel includes 20% C, 20% M, 80% Y, and 10% K, the weighted sum determined by combining the tone values is 60 (i.e., 20×1+20×1+80×0+10×2=60). The tone classification engine 108 may apply a threshold or a plurality of thresholds to each weighted sum for a given pixel to classify a tone of the pixel as light or dark. For the example of the CMYK weights of {1, 1, 0, 2} and the weighted sum of 60, assuming that a threshold of 80 represents a light tone, the tone classification engine 108 may classify the pixel as a light tone pixel.

With respect to tonal classification by the tone classification engine 108, in some examples, the tone classification engine 108 may apply a threshold or a plurality of thresholds to each weighted sum for a given pixel to classify a tone of the pixel along a multi-level scale. For the example of the CMYK weights of {1, 1, 0, 2} and the weighted sum of 60, assuming that a threshold of 80 represents a light tone, a threshold of 200 represents a dark tone, and any weighted sum between 80-200 represents a medium tone, the tone classification engine 108 may classify the pixel as a light tone pixel along such a multi-level scale.

With respect to tonal classification by the tone classification engine 108, in some examples, in addition to or instead of determining a weighted sum of the tone values across all printing material separations for a given pixel, the tone classification engine 108 may apply various statistical analysis with respect to the weighted sum of the tone values. For example, the tone classification engine 108 may determine a mean (or another statistical value) corresponding to the weighted tone values across printing material separations for a given pixel. The mean may then be compared to a mean-based tone threshold to classify a tone of the pixel, and thus a tone of an object as disclosed herein.

The print mode selection engine 112 may select the specified print mode 114 of the plurality of print modes 116 to meet the classification of the tone of each object. In this regard, the print mode selection engine 112 may determine whether a resulting tonal classification pixel map 124 warrants the use of a low-grain print mode for the print data 106. The tonal classification pixel map 124 may represent a map of classifications of an image formed by the print data 106. For example, each of the pixels of an image formed by the print data 106 may be classified as light, medium, and dark (or other types of classifications). For example, if any pixel (or any object) is classified as a light tone, the print mode selection engine 112 may select a low-grain print mode for the further rendering 120.

In some examples, the tone classification engine 108 may filter the resulting tonal classification pixel map 124 to identify larger, continuous areas (i.e., objects 110 as disclosed herein) of lighter tones. This is because small areas of lighter tones may be the result of noisy image content that may not benefit from the use of a low-grain print mode. Thus, the tone classification engine 108 may filter the resulting tonal classification pixel map 124 to identify any object of the objects 110 that may be classified, for example, as light, from classifications that include light, medium, and dark (or additional ranges of classifications).

In some examples, the print mode selection engine 112 may apply other types of print mode determination processes to identify lighter tone areas. In this regard, the print mode selection engine 112 may operate in conjunction with a multi-level classification process with respect to the tonal classification by the tone classification engine 108. For example, in order to determine a particular print mode, the print mode selection engine 112 may use multiple classification ranges (e.g., on a scale of 1-5, where 1 corresponds to a light pixel, 2 corresponds to a medium-light pixel, 3 corresponds to a medium pixel, 4 corresponds to a medium-dark pixel, and 5 corresponds to a dark pixel, etc.) to classify a particular pixel (or object).

In some examples, with respect to print mode determination, the print mode selection engine 112 may use an object that includes a predetermined number of pixels (e.g., 40), and use a tone score average to determine a particular print mode. For example, if an average is less than 1, the print mode selection engine 112 may determine that a pixel includes a light tone, and thus use a low-grain print mode.

In some examples, the print mode selection engine 112 may implement a multi-level classification if there are multiple grain quality print mode options to select from. For example, assuming that print mode options include small grain quality, medium grain quality, and large grain quality, in this regard, multiple classification ranges (e.g., on a scale of 1-5, where 1 corresponds to a light pixel, 2 corresponds to a medium-light pixel, 3 corresponds to a medium pixel, 4 corresponds to a medium-dark pixel, and 5 corresponds to a dark pixel) may be used to classify a particular pixel (or object).

The print engine 118 may generate, based on the specified print mode 114, the further rendering 120 of the print data 106. For example, the print engine 118 may generate raster data based at least in part on the further rendering 120, and generate, for the printing device 122, further print data including the raster data and the specified print mode 114. In this regard, once the print mode quality is selected, this information may be forwarded along with the raster data to the printing device 122 to specify the print mode to be used.

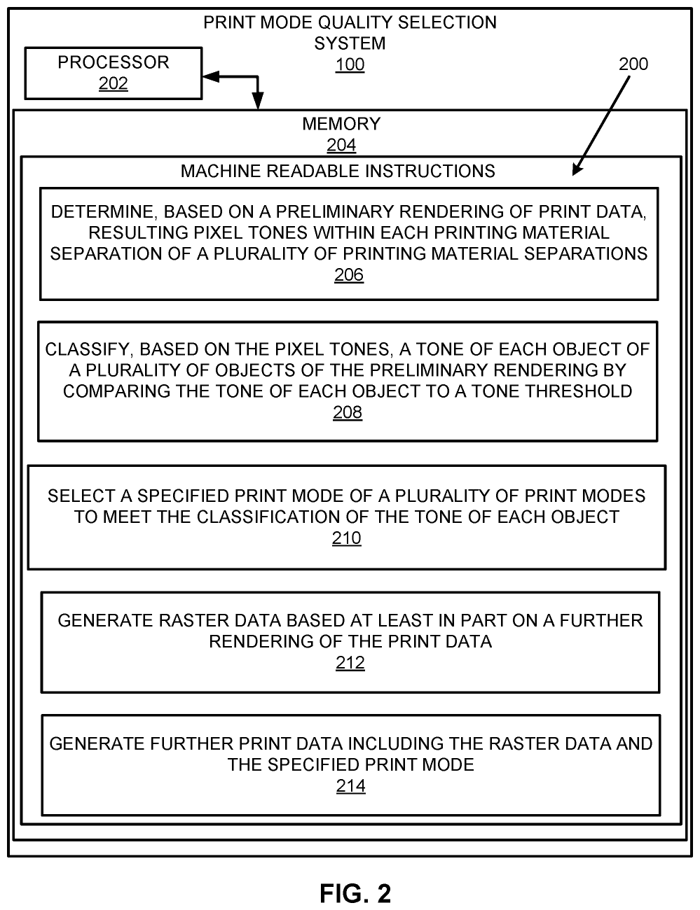

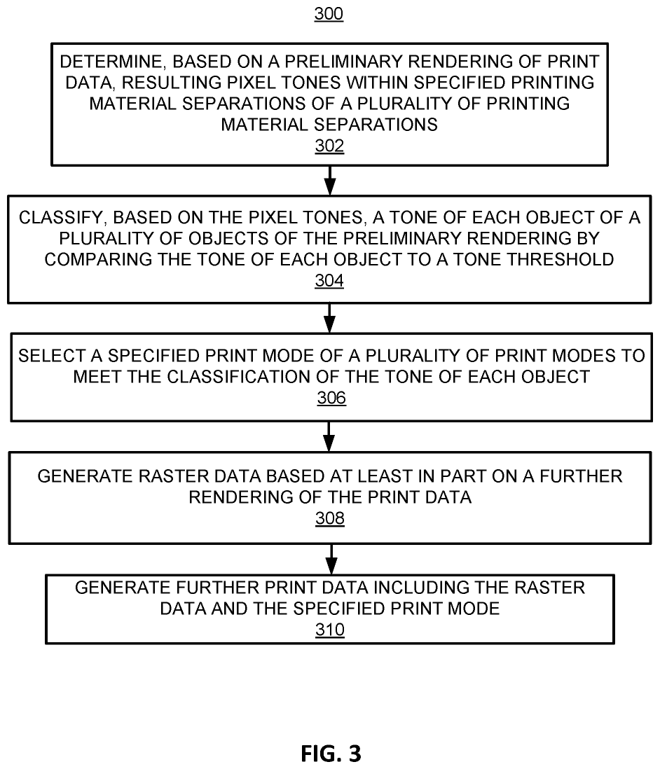

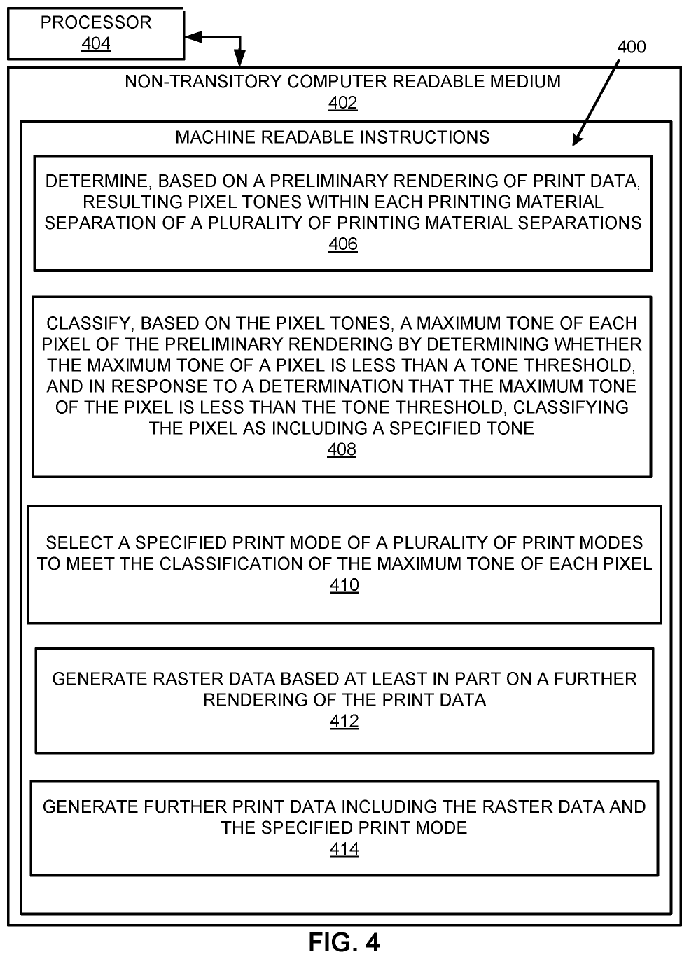

FIGS. 2-4 respectively illustrate a block diagram 200, a flowchart of a method 300, and a further block diagram 400 for print mode quality selection, according to examples. The block diagram 200, the method 300, and the block diagram 400 may be implemented on the system 100 described above with reference to FIG. 1 by way of example and not limitation. The block diagram 200, the method 300, and the block diagram 400 may be practiced in other systems. In addition to showing the block diagram 200, FIG. 2 shows hardware of the system 100 that may execute the instructions of the block diagram 200. The hardware may include a processor 202, and a memory 204 storing machine readable instructions that when executed by the processor cause the processor to perform the instructions of the block diagram 200. The memory 204 may represent a non-transitory computer readable medium. FIG. 3 may represent a method for print mode quality selection, and the steps of the method. FIG. 4 may represent a non-transitory computer readable medium 402 having stored thereon machine readable instructions to provide print mode quality selection. The machine readable instructions, when executed, cause a processor 404 to perform the instructions of the block diagram 400 also shown in FIG. 4.

The processor 202 of FIG. 2 and/or the processor 404 of FIG. 4 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 402 of FIG. 4), such as hardware storage devices (e.g., RAM (random access memory), ROM (read only memory), EPROM (erasable, programmable ROM), EEPROM (electrically erasable, programmable ROM), hard drives, and flash memory). The memory 204 may include a RAM, where the machine readable instructions and data for a processor may reside during runtime.

Referring to FIGS. 1-2, and particularly to the block diagram 200 shown in FIG. 2, at block 206, the memory 204 may include instructions to determine (e.g., by the pixel tone determination engine 102), based on the preliminary rendering 104 of the print data 106, resulting pixel tones within each printing material separation of a plurality of printing material separations. According to an example, a printing material separation may represent a printing material plane of the preliminary rendering 104.

At block 208, the memory 204 may include instructions to classify (e.g., by the tone classification engine 108), based on the pixel tones, a tone of each object of the plurality of objects 110 of the preliminary rendering 104 by comparing the tone of each object to a tone threshold. According to an example, an object may include a plurality of adjacently disposed pixels.

At block 210, the memory 204 may include instructions to select (e.g., by the print mode selection engine 112) a specified print mode of the plurality of print modes 116 to meet the classification of the tone of each object.

At block 212, the memory 204 may include instructions to generate (e.g., by the print engine 118) raster data based at least in part on the further rendering 120 of the print data 106.

At block 214, the memory 204 may include instructions to generate (e.g., by the print engine 118) further print data 106 including the raster data and the specified print mode.

Referring to FIGS. 1 and 3, and particularly FIG. 3, for the method 300, at block 302, the method may include determining (e.g., by the pixel tone determination engine 102), based on the preliminary rendering 104 of the print data 106, resulting pixel tones within specified printing material separations of a plurality of printing material separations. According to an example, the specified printing material separations represent printing material separations that include a predetermined impact on a pixel tone.

At block 304, the method 300 may include classifying (e.g., by the tone classification engine 108), based on the pixel tones, a tone of each object of a plurality of objects 110 of the preliminary rendering 104 by comparing the tone of each object to a tone threshold.

At block 306, the method 300 may include selecting (e.g., by the print mode selection engine 112) a specified print mode of a plurality of print modes 116 to meet the classification of the tone of each object.

At block 308, the method 300 may include generating (e.g., by the print engine 118) raster data based at least in part on the further rendering 120 of the print data 106.

At block 310, the method 300 may include generating (e.g., by the print engine 118) further print data 106 including the raster data and the specified print mode.

Referring to FIGS. 1 and 4, and particularly FIG. 4, for the block diagram 400, at block 406, the non-transitory computer readable medium 402 may include instructions to determine (e.g., by the pixel tone determination engine 102), based on the preliminary rendering 104 of the print data 106, resulting pixel tones within each printing material separation of a plurality of printing material separations.

At block 408, the non-transitory computer readable medium 402 may include instructions to classify (e.g., by the tone classification engine 108), based on the pixel tones, a maximum tone of each pixel of the preliminary rendering 104 by determining whether the maximum tone of a pixel is less than a tone threshold, and in response to a determination that the maximum tone of the pixel is less than the tone threshold, classifying the pixel as including a specified tone.

At block 410, the non-transitory computer readable medium 402 may include instructions to select (e.g., by the print mode selection engine 112) a specified print mode of the plurality of print modes 116 to meet the classification of the maximum tone of each pixel.

At block 412, the non-transitory computer readable medium 402 may include instructions to generate (e.g., by the print engine 118) raster data based at least in part on the further rendering 120 of the print data 106.

At block 414, the non-transitory computer readable medium 402 may include instructions to generate (e.g., by the print engine 118) further print data 106 including the raster data and the specified print mode.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A system comprising:
a pixel tone determination engine to determine, based on a preliminary rendering of print data, resulting pixel tones within each printing material separation of a plurality of printing material separations, wherein a printing material separation represents a printing material plane of the preliminary rendering;
a tone classification engine to classify, based on the pixel tones, a tone of each object of a plurality of objects of the preliminary rendering by comparing the tone of each object to a tone threshold, wherein an object includes a plurality of adjacently disposed pixels;
a print mode selection engine to select a specified print mode of a plurality of print modes to meet the classification of the tone of each object; and
a print engine to:
generate raster data based at least in part on a further rendering of the print data; and
generate further print data including the raster data and the specified print mode.

2. The system according to claim 1, wherein the pixel tone determination engine is to determine, based on the preliminary rendering of print data, resulting pixel tones within each printing material separation of the plurality of printing material separations by:
generating a full-resolution rendering using a same color management as the further rendering of the print data, wherein the full-resolution rendering represents the preliminary rendering, and wherein the full-resolution rendering is at a same resolution as the further rendering of the print data; and
determining, based on the preliminary rendering of print data, resulting pixel tones within each printing material separation of the plurality of printing material separations.

3. The system according to claim 1, wherein the pixel tone determination engine is to determine, based on the preliminary rendering of print data, resulting pixel tones within each printing material separation of the plurality of printing material separations by:
generating a low-resolution rendering using a same color management as the further rendering of the print data, wherein the low-resolution rendering represents the preliminary rendering, and wherein the low-resolution rendering is at a lower resolution compared to the further rendering of the print data; and
determining, based on the preliminary rendering of print data, resulting pixel tones within each printing material separation of the plurality of printing material separations.

4. The system according to claim 1, wherein the tone classification engine is to classify, based on the pixel tones, the tone of each object of the plurality of objects of the preliminary rendering by comparing the tone of each object to the tone threshold by:
classifying a maximum tone of each pixel of the preliminary rendering by
determining whether the maximum tone of a pixel is less than the tone threshold, and
in response to a determination that the maximum tone of the pixel is less than the tone threshold, classifying the pixel as including a specified tone;
classifying, based on the specified tone of each pixel, the tone of each object of the plurality of objects by determining whether a predetermined number of the classified pixels of an object of the plurality of objects include the specified tone; and
in response to a determination that the predetermined number of the classified pixels of the object of the plurality of objects include the specified tone, classifying the tone of the object as the specified tone.

5. The system according to claim 4, wherein
the specified tone is a light tone from a range of tones that include light and dark tones, and
the print mode selection engine is to select, based on the specified tone, a low-grain print mode of the plurality of print modes that include low-grain and high-grain print modes.

6. The system according to claim 1, wherein the tone classification engine is to classify, based on the pixel tones, the tone of each object of the plurality of objects of the preliminary rendering by comparing the tone of each object to the tone threshold by:
classifying a maximum tone of each pixel of the preliminary rendering by
determining whether the maximum tone of a pixel is less than the tone threshold,
in response to a determination that the maximum tone of the pixel is less than the tone threshold, classifying the pixel as including a first specified tone, and
in response to a determination that the maximum tone of the pixel is greater than the tone threshold, classifying the pixel as including a second specified tone;
classifying, based on the first and second specified tones of each pixel, the tone of each object of the plurality of objects by determining
whether a predetermined number of the classified pixels of an object of the plurality of objects include the first specified tone, and
whether a predetermined number of the classified pixels of the object of the plurality of objects include the second specified tone; and
in response to a determination that the predetermined number of the classified pixels of the object of the plurality of objects include the first specified tone or the predetermined number of the classified pixels of the object of the plurality of objects include the second specified tone, classifying the tone of the object as the first or the second specified tone.

7. The system according to claim 1, wherein the pixel tone determination engine is to determine, based on the preliminary rendering of print data, resulting pixel tones within each printing material separation of the plurality of printing material separations, and the tone classification engine is to classify, based on the pixel tones, the tone of each object of the plurality of objects of the preliminary rendering by comparing the tone of each object to the tone threshold by:
determining, based on the preliminary rendering of print data, resulting pixel tones within each printing material separation of the plurality of printing material separations by
multiplying each printing material separation by a weight corresponding to a type of the printing material separation, and
determining, based on the multiplied printing material separations, a combined pixel tone value for each pixel;
classifying the combined pixel tone value of each pixel of the preliminary rendering by
determining whether the combined pixel tone value of a pixel is less than the tone threshold, and
in response to a determination that the combined pixel tone value of the pixel is less than the tone threshold, classifying the pixel as including a specified tone;
classifying, based on the specified tone of each pixel, the tone of each object of the plurality of objects by determining whether a predetermined number of the classified pixels of an object of the plurality of objects include the specified tone; and
in response to a determination that the predetermined number of the classified pixels of the object of the plurality of objects include the specified tone, classifying the tone of the object as the specified tone.

8. A method for print mode quality selection comprising:
determining, based on a preliminary rendering of print data, resulting pixel tones within specified printing material separations of a plurality of printing material separations, wherein
a printing material separation represents a printing material plane of the preliminary rendering, and
the specified printing material separations represent printing material separations that include a predetermined impact on a pixel tone;
classifying, based on the pixel tones, a tone of each object of a plurality of objects of the preliminary rendering by comparing the tone of each object to a tone threshold, wherein an object includes a plurality of adjacently disposed pixels;
selecting, by a processor, a specified print mode of a plurality of print modes to meet the classification of the tone of each object;
generating raster data based at least in part on a further rendering of the print data; and
generating further print data including the raster data and the specified print mode.

9. The method according to claim 8, wherein for the plurality of printing material separations associated with a CMYK color scheme, where C represents cyan, M represents magenta, Y represents yellow, and K represents black, the specified printing material separations include C, M, and K.

10. A non-transitory computer readable medium having stored thereon machine readable instructions to provide print mode quality selection, the machine readable instructions, when executed, cause a processor to:
determine, based on a preliminary rendering of print data, resulting pixel tones within each printing material separation of a plurality of printing material separations, wherein a printing material separation represents a printing material plane of the preliminary rendering;
classify, based on the pixel tones, a maximum tone of each pixel of the preliminary rendering by
determining whether the maximum tone of a pixel is less than a tone threshold, and
in response to a determination that the maximum tone of the pixel is less than the tone threshold, classifying the pixel as including a specified tone;
select a specified print mode of a plurality of print modes to meet the classification of the maximum tone of each pixel;
generate raster data based at least in part on a further rendering of the print data; and
generate further print data including the raster data and the specified print mode.

11. The non-transitory computer readable medium of claim 10, wherein the machine readable instructions to select the specified print mode of the plurality of print modes to meet the classification of the maximum tone of each pixel, when executed, further cause the processor to:
classify, based on the classification of the maximum tone of each pixel, a tone of each object of a plurality of objects of the preliminary rendering by comparing the tone of each object to a further tone threshold, wherein an object includes a plurality of adjacently disposed pixels; and
select the specified print mode of the plurality of print modes to meet the classification of the tone of each object.

12. The non-transitory computer readable medium of claim 10, wherein the machine readable instructions to select the specified print mode of the plurality of print modes to meet the classification of the maximum tone of each pixel, when executed, further cause the processor to:
classify, based on the classification of the maximum tone of each pixel, a tone of each object of a plurality of objects of the preliminary rendering by
determining whether a predetermined number of the classified pixels of an object of the plurality of objects include the specified tone, and
in response to a determination that the predetermined number of the classified pixels of the object of the plurality of objects include the specified tone, classifying the tone of the object as the specified tone, wherein an object includes a plurality of adjacently disposed pixels; and
select the specified print mode of the plurality of print modes to meet the classification of the tone of each object.

13. The non-transitory computer readable medium of claim 10, wherein the specified tone is a light tone from a range of tones that include light and dark tones, and the machine readable instructions to select the specified print mode of the plurality of print modes to meet the classification of the maximum tone of each pixel, when executed, further cause the processor to:
select, based on the specified tone, a low-grain print mode of the plurality of print modes that include low-grain and high-grain print modes.

14. The non-transitory computer readable medium of claim 10, wherein the machine readable instructions to select the specified print mode of the plurality of print modes to meet the classification of the maximum tone of each pixel, when executed, further cause the processor to:
classify, based on the classification of the maximum tone of each pixel, a tone of each object of a plurality of objects of the preliminary rendering by
determining whether a predetermined number of the classified pixels of an object of the plurality of objects include the specified tone,
determining whether a predetermined number of the classified pixels of the object of the plurality of objects include a different specified tone, and
in response to a determination that the predetermined number of the classified pixels of the object of the plurality of objects include the specified tone or the predetermined number of the classified pixels of the object of the plurality of objects include the different specified tone, classifying the tone of the object as the specified tone or the different specified tone, wherein an object includes a plurality of adjacently disposed pixels; and
select the specified print mode of the plurality of print modes to meet the classification of the tone of each object.

15. The non-transitory computer readable medium of claim 10, wherein the machine readable instructions to determine, based on the preliminary rendering of print data, resulting pixel tones within each printing material separation of the plurality of printing material separations, and classify, based on the pixel tones, the maximum tone of each pixel of the preliminary rendering, when executed, further cause the processor to:
determine, based on the preliminary rendering of print data, resulting pixel tones within each printing material separation of the plurality of printing material separations by
multiplying each printing material separation by a weight corresponding to a type of the printing material separation, and
determining, based on the multiplied printing material separations, a combined pixel tone value for each pixel;
classify the combined pixel tone value of each pixel of the preliminary rendering by
determining whether the combined pixel tone value of a pixel is less than a further tone threshold, and
in response to a determination that the combined pixel tone value of the pixel is less than the further tone threshold, classifying the pixel as including the specified tone;
classify, based on the specified tone of each pixel, a tone of each object of a plurality of objects by determining whether a predetermined number of the classified pixels of an object of the plurality of objects include the specified tone, wherein an object includes a plurality of adjacently disposed pixels; and
in response to a determination that the predetermined number of the classified pixels of the object of the plurality of objects include the specified tone, classify the tone of the object as the specified tone.
